(19) United States
(12) Patent Application Publication
(10) Pub. No.: US 2019/0070779 A1
(43) Pub. Date: Mar. 7, 2019

(54) 3D Printing Device for Recycling Powders and Operation Method Thereof

(71) Applicant: Tongtai Machine & Tool Co., Ltd., Kaohsiung City (TW)

(72) Inventors: Hsin-Pao Chen, Kaohsiung City (TW); Huai-En Kao, Kaohsiung City (TW); Wei-Lin Wang, Kaohsiung City (TW); Jui-Hsiung Yen, Kaohsiung City (TW)

(73) Assignee: Tongtai Machine & Tool Co., Ltd., Kaohsiung City (TW)

(21) Appl. No.: 15/856,145

(22) Filed: Dec. 28, 2017

(30) Foreign Application Priority Data
Sep. 4, 2017 (CN) 201710785913.2

(51) Int. Cl. B29C 64/357; B29C 64/153; B29C 64/214; B29C 64/393; B33Y 10/00; B33Y 30/00; B33Y 50/02; B33Y 40/00

(52) U.S. Cl. CPC B29C 64/357; B29C 64/153; B29C 64/214; B33Y 40/00; B33Y 10/00; B33Y 30/00; B33Y 50/02; B29C 64/393

(57) ABSTRACT

A 3D printing device for recycling powders and an operation method thereof are provided. The 3D printing device for recycling powders has a base, a processing plate, an optical module, and a powder conveying module. The speed of production process of 3D printed workpieces can be increased, the waiting time in the production process can be reduced, and the process stability can be improved by disposing the powder conveying module.

### FIELD OF INVENTION

The present disclosure relates to a 3D printing device and an operation method of the 3D printing device, and in particular to a 3D printing device for recycling powders and an operation method of the 3D printing device.

### BACKGROUND OF INVENTION

The current laminating manufacturing technology is mainly based on laser laminating manufacturing technology. The laser laminating manufacturing technology uses a laser melting principle. A layer of the powders is spread according to a 2D geometric shape cut from a 3D model, and the layers of the powders are melted by the laser to form the 2D geometric shape. The workpiece is stacked in the layers so that the complex structure of the workpiece can be completed; traditional processing cannot produce it.

However, the powders of the layers are limited to a feeding platform, and one or more foreign powders cannot be provided. Gas is inhaled or exhausted onto the layers and cannot effectively provide the powders recovery for a long time. The working range is limited by a flowing distance and wind speed of a gas field. In addition, laser scanning can be limited by the direction of the gas flow and cannot effectively provide a better scanning method. When more than one component needs to be made within a certain working platform, laser scanning cannot parallel with the gas field to process. The production process is arranged in the scanning order of the components according to the direction of the gas field, and more than one component cannot be processed at the same time. It results in increasing the processing time and cannot be reduced effectively.

As a result, it is necessary to provide an improved 3D printing device for recycling powders and an operation method of the 3D printing device to solve the problems existing in the conventional technologies, as described above.

### SUMMARY OF INVENTION

An object of the present disclosure is to provide a 3D printing device for recycling powders and an operation method of the 3D printing device, wherein the speed of a production process of 3D printed workpieces can be increased, the waiting time in the production process can be reduced, and the process stability can be improved by disposing a powder conveying module.

To achieve the above objects, the present disclosure provides a 3D printing device for recycling powders. The 3D printing device comprises a base, a processing plate, an optical module, and a powder conveying module, wherein the processing plate is disposed on the base and configured to receive powders. The optical module includes laser sources which is disposed above the processing plate and configured to emit lasers to the powders for forming a workpiece. The powder conveying module includes two powder channels, two powder channel openings, two gas channels, and two gas channel openings. The two powder channels are disposed above the processing plate. The two powder channel openings are separately formed on a first end of the powder channels, located at two sides of the lasers, respectively, and configured to dispense the powders to the processing plate. The two gas channels are disposed above the processing plate. The two gas channel openings are separately formed on a first end of the gas channels, and located at two sides of the lasers, respectively, wherein one of the gas channel openings is configured to exhaust a gas above the processing plate, and the other of the gas channel openings is configured to inhale the gas and unwanted powders generated by using the lasers to melt the powders on the processing plate, wherein a gas flowing field is formed between the two gas channel openings.

In one embodiment of the present disclosure, the powder conveying module further comprises at least two powder tanks, and the powder tanks are separately disposed at a second end of the powder channels.

In one embodiment of the present disclosure, the powder conveying module further comprises at least two scrapers, the scrapers are disposed on the powder channel openings, respectively, and configured to touch the processing plate.

In one embodiment of the present disclosure, the base comprises a bracket and a dropping mechanism, and the dropping mechanism is disposed on the bracket and configured to lift or lower the processing plate.

In one embodiment of the present disclosure, the 3D printing device further comprises a vertical and horizontal movement mechanism disposed on the base and a rotating mechanism disposed on the vertical and horizontal movement mechanism, wherein the optical module and the powder conveying module are disposed on the rotating mechanism, and rotated by driving the rotating mechanism.

In one embodiment of the present disclosure, the optical module further comprises at least one coaxial sensor component assembled on the laser sources and configured to optically sense the processing plate for obtaining a coaxial visual image and at least one galvanometer component assembled on the laser sources and configured to scan the lasers generated by the laser sources.

In one embodiment of the present disclosure, a plurality of the laser sources of the optical module are arranged along a distribution direction, and each of directions of the lasers generated by the laser sources and a direction of the gas flowing field are orthogonal to each other or commonly define an included angle greater than 45°.

To achieve the above objects, the present disclosure provides an operation method of a 3D printing device for recycling powders. The operation method comprises: a powder feeding step of feeding an amount of powders to at least one powder channel through at least one powder tank so that the powders are dispensed to a processing plate through a powder channel opening; a powder flattening step of moving the powder channel opening to drive at least one scraper disposed on the powder channel opening to flatten the powders on the processing plate; a fusing step of moving laser sources so that lasers emitted by the laser sources melts the powders on the processing plate for forming a workpiece; a powder recycling step of inhaling unwanted powders generated by using the lasers to melt the powders on the processing plate through forming a gas flowing field defined between two gas channel openings located at two sides of the lasers when the lasers melts the powders on the processing plate; and a completion determining step of lowering the processing plate a height and determining whether the workpiece is completed, wherein the workpiece is removed if the workpiece is completed, or the powder feeding step is re-executed if the workpiece is not completed.

In one embodiment of the present disclosure, the operation method further comprises a position returning step before the powder feeding step, the position returning step is configured to move the laser sources so that the laser emitted by the laser sources returns to an original position on the processing plate.

In one embodiment of the present disclosure, in the powder feeding step, the lasers are moved from an original position on the processing plate to a final position on the processing plate along a scanning path, and the powder channel opening is driven to synchronously move with the lasers, wherein the original position and the final position are located at two opposite sides of the processing plate, respectively, and the scanning path is a zig-zag route.

As described above, the processing plate can move quickly along an X axis, Y axis, and Z axis and rotate along a plane by driving the dropping mechanism, the vertical and horizontal movement mechanism, and the rotating mechanism. The galvanometer component can adjust the emitting angle of the lasers to reduce the limitation a scanning direction of the lasers and the gas flowing field are orthogonal so that the working efficiency of forming the workpiece can be increased, and the working range of the processing area of the workpiece can be improved. In addition, the speed limitation that the gas flowing field cannot inhale the unwanted powders for a long time can be reduced by using the powder conveying module so that the problem that the unwanted powders cannot be removed can be avoided. Thus, the speed of production process of 3D printed workpieces can be increased, the waiting time in the production process can be reduced, and the process stability can be improved to ensure the quality of the workpiece.

### DESCRIPTION OF DRAWINGS

FIG. 1 is a perspective view of a 3D printing device for recycling powders according to a preferred embodiment of the present disclosure.

FIG. 2 is a side view of the 3D printing device for recycling powders according to the preferred embodiment of the present disclosure.

FIGS. 3 and 4 are schematic views of the 3D printing device for recycling powders according to the preferred embodiment of the present disclosure.

FIGS. 5 and 6 are schematic views of a scanning path of the 3D printing device for recycling powders according to the preferred embodiment of the present disclosure.

FIG. 7 is a flow chart of an operation method of the 3D printing device for recycling powders according to the preferred embodiment of the present disclosure.

### DETAILED DESCRIPTION OF PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

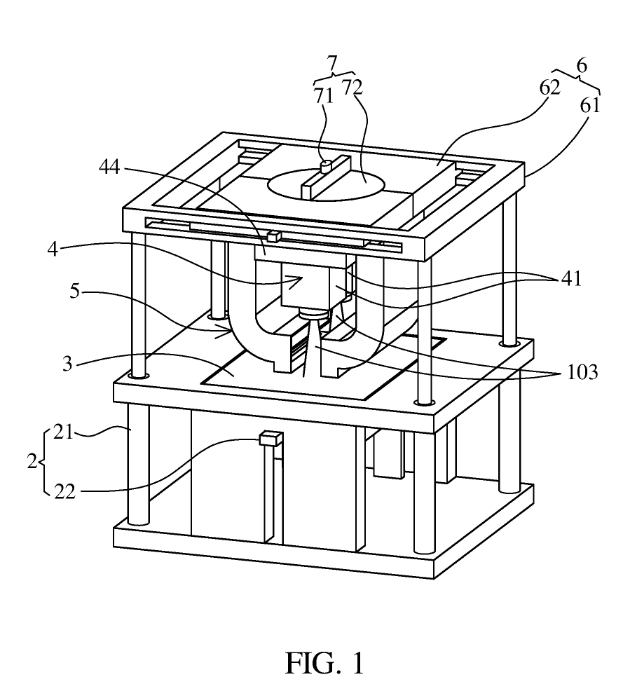

Referring to FIGS. 1-3, a perspective view of a 3D printing device for recycling powders according to a preferred embodiment of the present disclosure is provided, wherein the 3D printing device comprises a base 2, a processing plate 3, an optical module 4, a powder conveying module 5, a vertical and horizontal movement mechanism 6, and a rotating mechanism 7. The detailed structure of each component, assembly relationships, and principle of operation in the present invention will be described in detail hereinafter.

Referring to FIG. 1, the base 2 comprises a bracket 21 and a dropping mechanism 22, wherein the processing plate 3 is movably assembled on the bracket 21, and the dropping mechanism 22 is disposed on the bracket 21 and located under the processing plate 3. The dropping mechanism 22 and the processing plate 3 are synchronously moved. In other words, the processing plate 3 can be lifted or lowered when the dropping mechanism 2 is driven to lift or lower so that the processing plate 3 is moved between a lowering position away from the powder conveying module 5 and a lifting position close to the powder conveying module 5.

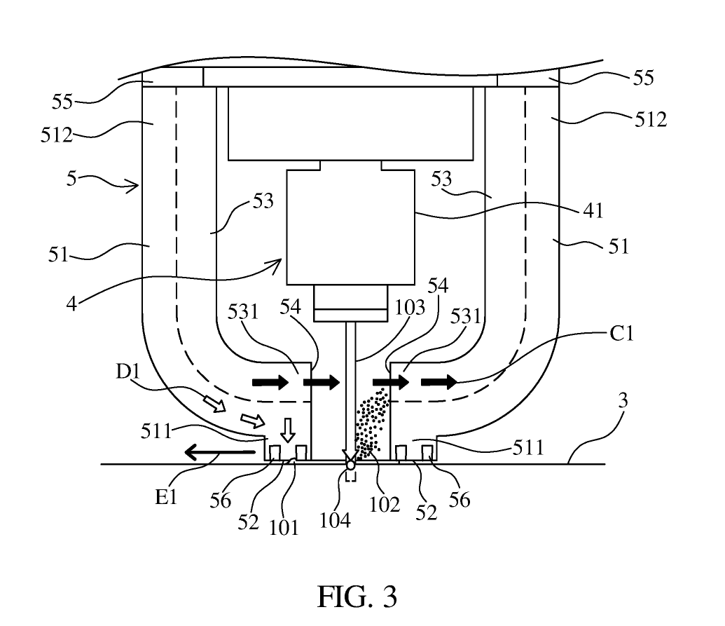

Referring to FIG. 1, the processing plate 3 is disposed on the dropping mechanism 22 of the base 2 and configured to receive powders dispensed from the powder conveying module 5 (shown in FIG. 3). The processing plate 3 can be lifted to the lifting position closing to the powder conveying module 5 by driving the dropping mechanism 22, and lowered to the lowering position away the powder conveying module 5 by driving the dropping mechanism 22.

Referring to FIGS. 1-3, the optical module 4 includes laser sources 41, at least one coaxial sensor component 42, at least one galvanometer component 43, and a longitudinal adjusting base 44, wherein the laser sources 41 (such as fiber laser or semiconductor laser) is disposed above the processing plate 3 and configured to emit lasers 103 to the powders 101 (shown in FIG. 3) on the processing plate 3 so that the powders are heated, melted, and solidified to form a workpiece. The coaxial sensor component 42 is assembled on the laser sources 41 and configured to optically sense the processing plate 3 with sensing components, such as thermometer, thermal imager, charge coupled device (CCD), and photo diode, for obtaining a coaxial visual image and spectrum of reflected light. The galvanometer component is assembled on the laser sources 41 and configured to scan the lasers generated by the laser sources 41. The longitudinal adjusting base 44 is disposed on the vertical and horizontal movement mechanism 6 and configured to assemble the laser sources 41 and adjust the laser sources 41 to move up or to move down slightly along a longitudinal direction. In the preferred embodiment, the optical module 4 includes two laser sources 41, and the laser sources 41 are arranged along a distribution direction, and each of directions of the lasers generated by the laser sources 41 and a direction of a gas flowing field are orthogonal to each other or commonly define an included angle greater than 45°.

Referring to FIGS. 1 and 3. The powder conveying module 5 includes two powder channels 51, two powder channel openings 52, two gas channels 53, two gas channel openings 54, at least two powder tanks 55, and at least two scrapers 56. The two powder channels 51 are disposed above the processing plate 3. The powder channel openings 52 are separately formed on a first end 511 of the powder channels 51, and the first end 511 of the powder channels 51 are located at two sides of the lasers emitted from the laser sources 41, respectively, and the powder channels 51 are configured to convey the powders 101 and dispensed the powders 101 to the processing plate 3. The gas channels 53 are disposed above the processing plate 3. Each of the gas channel 53 is disposed on the corresponding powder channel 51. The two gas channel openings 54 are separately formed on a first end 531 of the gas channels 53, and the first end 531 of the gas channels 53 are located at two sides of the lasers emitted from the laser sources 41, respectively. The gas channels 53 are configured to convey the gas, wherein one of the gas channel openings 54 is configured to exhaust a gas above the processing plate 3, and the other of the gas channel openings 54 is configured to inhale the gas and unwanted powders 102 generated by using the lasers to melt the powders 101 on the processing plate 3, wherein the gas flowing field is formed between the two gas channel openings 54. The powder tanks 55 are configured to store the powders 101, and the powder tanks 55 are separately disposed at a second end 512 of the powder channels 51. The scrapers 56 are disposed on the powder channel openings 52, respectively, and configured to touch the processing plate 3 for flattening the powders 101 on the processing plate 3. In addition, each of the gas channel 53 is adjoined on the corresponding powder channel 51, and one of the gas channel openings 54 configured to exhaust the gas and one of the powder channel openings 52 configured to dispense the powders are located at the same side of the lasers 103.

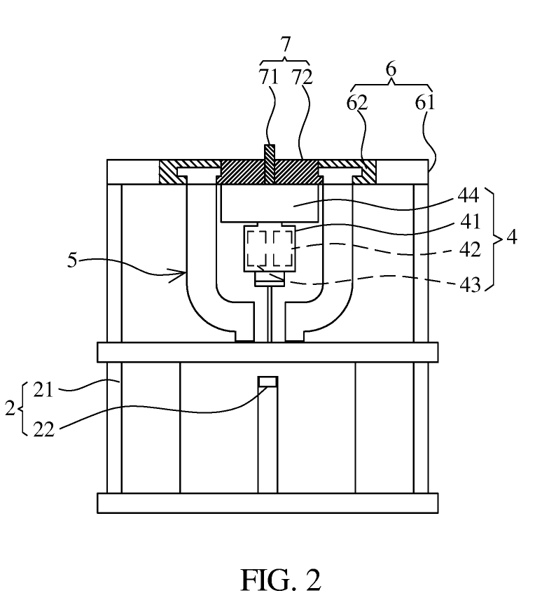

Referring to FIGS. 1 and 2, the vertical and horizontal movement mechanism 6 includes a moving bracket 61 and a moving base 62, wherein the moving bracket 61 is assembled on the base 2 and driven to move up and move down. The moving base 62 is assembled on the moving bracket 61 and driven to move horizontally so that the moving base 62 can be moved on the X axis-Y axis plane, and moved along Z axis by driving the moving bracket 61.

Referring to FIGS. 1 and 2, the rotating mechanism 7 is disposed on the moving base 62 of the vertical and horizontal movement mechanism 6, and the optical module 4 and the powder conveying module 5 are assembled on the rotating mechanism 7. The rotating mechanism 7 is pivoted on the moving base 62 so that the optical module 4 and the powder conveying module 5 can rotate with the rotating mechanism 7. The rotating mechanism 7 includes an inner rotating member 71 and an outer rotating member 72, wherein the outer rotating member 72 is disposed around the inner rotating member 71, wherein the inner rotating member 71 engages the optical module 4, and the outer rotating member 72 engages the powder conveying module 5. The inner rotating member 71 can be synchronously moved with the optical module 4, and the outer rotating member 72 can be synchronously moved with the powder conveying module 5.

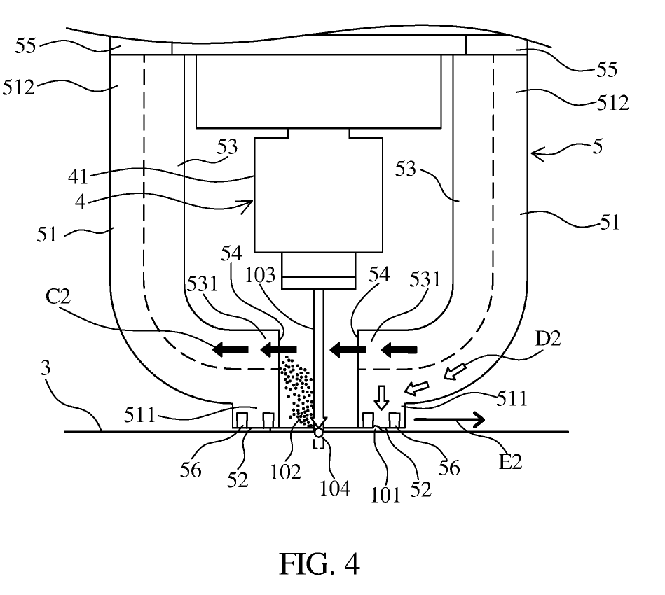

According to the described structure, the vertical and horizontal movement mechanism 6 and the rotating mechanism 7 can move the laser sources 41 to position and return to a position so that the lasers 103 emitted by the laser sources 41 can return to an original position on the processing plate 3. Valves or powder hoppers are controlled to feed an amount of powders to the powder tanks 55, and the type of the powders can be chosen so that the powders can be fed an amount of powders to at least one powder channel 51 through the powder tank 55 so that the powders are dispensed to the processing plate 3 through the powder channel opening 52. The vertical and horizontal movement mechanism 6 and the rotating mechanism 7 are driven to move the powder channel openings 52 for controlling the angle of a movement direction and a plane movement so that the scrapers 56 disposed on the powder channel openings 52 flatten the powders 101 on the processing plate 3. The powders on a designated position of the processing plate 3 are melted by moving the laser sources 41, wherein one or more lasers 103 can be controlled so that the lasers 103 emitted by the laser sources 41 melt the powders on the processing plate 3, and then the powders are solidified on the processing plate 3. When the lasers 103 melt the powders 101 to a melt pool 104 (as shown FIGS. 3 and 4), the gas flowing field formed between the two gas channel openings 54 located at two sides of the lasers 103 is used to inhale the gas and unwanted powders 102 generated by using the lasers 103 to melt the powders 101 on the processing plate 3. The gas channel openings 54 correspond to each other, and one of the gas channel openings 54 inhales the gas and the other of the gas channel openings 54 exhausts the gas. As shown FIG. 3, when the powder conveying module 5 is moved left along a direction E1, the left powder channel opening 52 feeds the powders along a direction D1. The gas flowing field flows from the left gas channel opening 54 to the right gas channel opening 54 along a direction C1. As shown FIG. 4, when the powder conveying module 5 is moved right along a direction E2, the right powder channel opening 52 feeds the powders along a direction D2. The gas flowing field flows from the right gas channel opening 54 to the left gas channel opening 54 along a direction C2. The gas of the gas flowing field is nitrogen (N2) or inert gas, such as argon (Ar) and helium (He). The flow between the two gas channel openings 54 is controlled with a certain flow rate so that the unwanted powders 102 generated by using the lasers 103 to melt the powders 101 can be recycled. Finally, the processing plate 3 is lowered a height to determine whether the workpiece is completed, wherein the workpiece is removed if the workpiece is completed, or the powder feeding step is re-executed if the workpiece is not completed.

As described above, the processing plate 3 can move quickly along the X axis, Y axis, and Z axis and rotate along a plane by driving the dropping mechanism 22, the vertical and horizontal movement mechanism 6, and the rotating mechanism 7. The galvanometer component 43 can adjust the emitting angle of the lasers 103 to reduce the limitation a scanning direction of the lasers and the gas flowing field are orthogonal so that the working efficiency of forming the workpiece can be increased, and the working range of the processing area of the workpiece can be improved. In addition, the speed limitation that the gas flowing field cannot inhale the unwanted powders for a long time can be reduced by using the powder conveying module 5. It can solve the problems of the prior art, the direction of the gas flowing field is fixed, and the scanning of the laser galvanometer is limited from the direction of the gas flowing field. When a moving direction of the lasers and the direction of the gas flowing field are parallel, the moving speed of the lasers is faster than the flowing speed of the gas flowing field so that the unwanted powders cannot be removed. In the preferred embodiment, each of the directions of the lasers 103 generated by the laser sources 41 and a direction of the gas flowing field are orthogonal to each other or commonly define an included angle greater than 45° so that the problem that the unwanted powders cannot be removed can be avoided. Thus, the speed of the production process of 3D printed workpieces can be increased, the waiting time in the production process can be reduced, and the process stability can be improved to ensure the quality of the workpiece. Furthermore, many types of the powders can be provided through disposing the powder tanks 55 and the powder channels 51 so that the workpiece is made by different materials to form a composite component.

Referring to FIG. 7 with reference to FIGS. 1 and 2, an operation method of the 3D printing device for recycling powders according to the preferred embodiment of the present disclosure is provided, and operated by said 3D printing device for recycling powders. The operation method comprises a position returning step S201, a powder feeding step S202, a powder flattening step S203, a fusing step S204, a powder recycling step S205, and a completion determining step S206. The detailed steps and principles of operation in the present invention will be described in detail hereinafter.

Referring to FIG. 7 with reference to FIGS. 1 and 2, in the position returning step S201, commands are provided to a vertical and horizontal movement mechanism 6 and a rotating mechanism 7 through a computer or numerical controller to move laser sources 41 for positioning or returning a processing plate 3 so that the laser sources 41 can be returned to an original position on the processing plate 3.

Referring to FIG. 7 with reference to FIGS. 1 and 2, in the powder feeding step S202, an amount of powders 101 are fed to at least one powder tank 55 by controlling valves or powder hoppers, and the type of the powders 101 can be chosen through the computer or numerical controller so that the powders 101 can be fed an amount of powders to at least one powder channel 51 through the powder tank 55. Thus, the powders 101 are dispensed to the processing plate 3 through the powder channel opening 52.

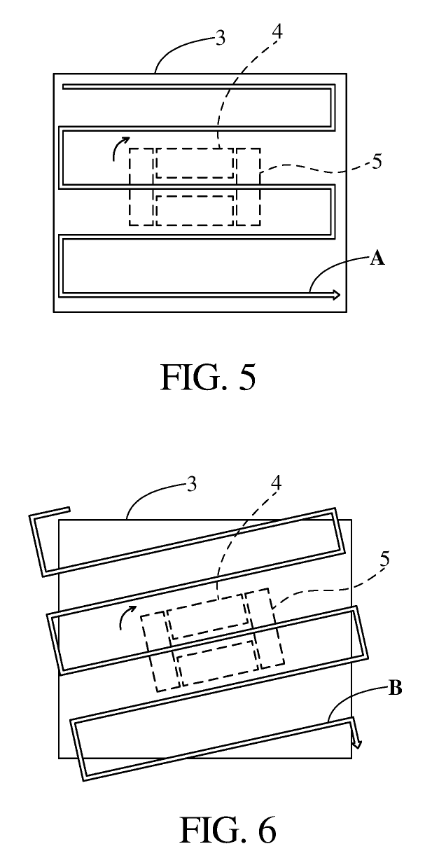

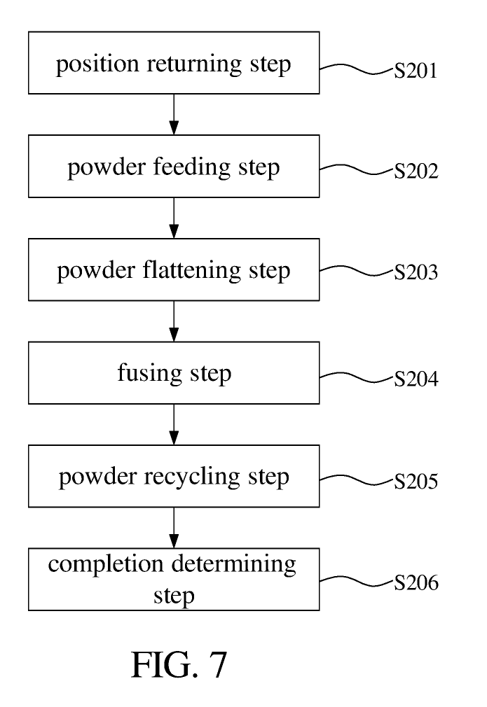

Referring to FIG. 7 with reference to FIGS. 1 and 2, in the powder flattening step S203, the vertical and horizontal movement mechanism 6 and the rotating mechanism 7 are driven through the computer or numerical controller to move the powder channel openings 52 for controlling the angle of a movement direction and a plane movement so that at least one scraper 56 disposed on the powder channel opening 52 flattens the powders 101 on the processing plate 3. In the preferred embodiment, the vertical and horizontal movement mechanism 6 and the rotating mechanism 7 are driven so that the lasers 103 is moved from an original position on the processing plate 3 to a final position on the processing plate 3 along a scanning path A shown in FIG. 5 or along a scanning path B shown in FIG. 6, and the powder channel opening 52 is driven to synchronously move with the lasers 103, wherein the original position and the final position are located at two opposite sides of the processing plate 3, respectively, and the scanning path is a zig-zag route. In addition, when the scanning path A shown in FIG. 5 or the scanning path B shown in FIG. 6 is implemented, the optical module 4 and the powder conveying module 5 can also be rotated through an inner rotating member 71 and an outer rotating member 72 of the rotating mechanism 7. Thus, a scanning direction of the optical module 4 and a feeding direction of the powder conveying module 5 can be adjusted so that compactness and firmness after melting the powder 101 can be improved.

Referring to FIG. 7 with reference to FIGS. 1 and 2, in the fusing step S204, the powders on a designated position of the processing plate 3 are melted by moving the laser sources 41 through the computer or numerical controller, wherein one or more lasers 103 can be controlled so that the lasers 103 emitted by the laser sources 41 melt the powders 101 on the processing plate 3, and then the powders 101 are solidified on the processing plate 3. Said steps are re-executed a few times to form the workpiece.

Referring to FIG. 7 with reference to FIGS. 1 and 2, in the powder recycling step S205, when the lasers 103 melt the powders 101 in the fusing step S204, the gas flowing field formed between the two gas channel openings 54 located at two sides of the lasers 103 is used to inhale the gas and unwanted powders 102 generated by using the lasers 103 to melt the powders 101 on the processing plate 3. The gas channel openings 54 correspond to each other, and one of the gas channel openings 54 inhales the gas and the other of the gas channel openings 54 exhausts the gas. The gas of the gas flowing field is nitrogen (N2) or inert gas, such as argon (Ar) and helium (He). The flow between the two gas channel openings 54 is controlled with a certain flow rate so that the unwanted powders 102 generated by using the lasers 103 to melt the powders 101 or other material (such as overheated gas, plasma material, and the powders is not melted but ascends on the processing plate 3) can be recycled through one of the gas channels 53 and filtered by an air filter.

Furthermore, as shown in FIG. 3, when the powder conveying module 5 is moved left along a direction E1, the left powder channel opening 52 feeds the powders along a direction D1. The gas flowing field flows from the left gas channel opening 54 to the right gas channel opening 54 along a direction C1. As shown FIG. 4, when the powder conveying module 5 is moved right along a direction E2, the right powder channel opening 52 feeds the powders along a direction D2. The gas flowing field flows from the right gas channel opening 54 to the left gas channel opening 54 along a direction C2.

Referring to FIG. 7 with reference to FIGS. 2 and 6, in the completion determining step S206, the processing plate 3 is lowered a height to determine whether the workpiece is completed, wherein the workpiece is removed if the workpiece is completed, or the powder feeding step is re-executed to the powder feeding step S202 if the workpiece is not completed until the workpiece is completed, wherein the workpiece has a component or components.

As described above, the processing plate 3 can move quickly along the X axis, Y axis, and Z axis and rotate along a plane by driving the dropping mechanism 22, the vertical and horizontal movement mechanism 6, and the rotating mechanism 7. The galvanometer component 43 can adjust the emitting angle of the lasers 103 to reduce the limitation a scanning direction of the lasers and the gas flowing field are orthogonal so that the working efficiency of forming the workpiece can be increased, and the working range of the processing area of the workpiece can be improved. In addition, the speed limitation that the gas flowing field cannot inhale the unwanted powders for a long time can be reduced by using the powder conveying module 5 so that the problem that the unwanted powders cannot be removed can be avoided. Thus, the speed of production process of 3D printed workpieces can be increased, the waiting time in the production process can be reduced, and the process stability can be improved to ensure the quality of the workpiece.

The present disclosure has been described with preferred embodiments thereof and it is understood that many changes and modifications to the described embodiments can be carried out without departing from the scope and the spirit of the invention that is intended to be limited only by the appended claims.

What is claimed is:

1. A 3D printing device for recycling powders, comprising:
a base;
a processing plate disposed on the base and configured to receive powders;
an optical module including laser sources which are disposed above the processing plate and configured to emit lasers to the powders for forming a workpiece; and
a powder conveying module including:
two powder channels disposed above the processing plate;
two powder channel openings separately formed on a first end of the powder channels, located at two sides of the lasers, respectively, and configured to dispense the powders to the processing plate;
two gas channels disposed above the processing plate; and
two gas channel openings separately formed on a first end of the gas channels, and located at two sides of the lasers, respectively, wherein one of the gas channel openings is configured to exhaust a gas above the processing plate, and the other of the gas channel openings is configured to inhale the gas and unwanted powders generated by using the lasers to melt the powders on the processing plate, wherein a gas flowing field is formed between the two gas channel openings.

2. The 3D printing device for recycling powders according to claim 1, wherein the powder conveying module further comprises at least two powder tanks, and the powder tanks are separately disposed at a second end of the powder channels.

3. The 3D printing device for recycling powders according to claim 1, wherein the powder conveying module further comprises at least two scrapers, the scrapers are disposed on the powder channel openings, respectively, and configured to touch the processing plate.

4. The 3D printing device for recycling powders according to claim 1, wherein the base comprises a bracket and a dropping mechanism, and the dropping mechanism is disposed on the bracket and configured to lift or lower the processing plate.

5. The 3D printing device for recycling powders according to claim 1, wherein the 3D printing device further comprises:
a vertical and horizontal movement mechanism disposed on the base; and
a rotating mechanism disposed on the vertical and horizontal movement mechanism;
wherein the optical module and the powder conveying module are disposed on the rotating mechanism, and rotated by driving the rotating mechanism.

6. The 3D printing device for recycling powders according to claim 1, wherein the optical module further comprises:
at least one coaxial sensor component assembled on the laser sources and configured to optically sense the processing plate for obtaining a coaxial visual image; and
at least one galvanometer component assembled on the laser sources and configured to scan the lasers generated by the laser sources.

7. The 3D printing device for recycling powders according to claim 1, wherein the laser sources of the optical module are arranged along a distribution direction, and each of directions of the lasers generated by the laser sources and a direction of the gas flowing field are orthogonal to each other or commonly define an included angle greater than 45°.

8. An operation method of a 3D printing device for recycling powders, comprising:
a powder feeding step of feeding an amount of powders to at least one powder channel through at least one powder tank so that the powders are dispensed to a processing plate through a powder channel opening;
a powder flattening step of moving the powder channel opening to drive at least one scraper disposed on the powder channel opening to flatten the powders on the processing plate;
a fusing step of moving laser sources so that lasers emitted by the laser sources melts the powders on the processing plate for forming a workpiece;
a powder recycling step of inhaling unwanted powders generated by using the lasers to melt the powders on the processing plate through forming a gas flowing field defined between two gas channel openings located at two sides of the lasers when the lasers melt the powders on the processing plate; and
a completion determining step of lowering the processing plate a height and determining whether the workpiece is completed, wherein the workpiece is removed if the workpiece is completed, or the powder feeding step is re-executed if the workpiece is not completed.

9. The operation method of the 3D printing device for recycling powders according to claim 8, wherein the operation method further comprises a position returning step before the powder feeding step, the position returning step is configured to move the laser sources so that the lasers emitted by the laser sources returns to an original position on the processing plate.

10. The operation method of the 3D printing device for recycling powders according to claim 8, wherein in the powder feeding step, the lasers are moved from an original position on the processing plate to a final position on the processing plate along a scanning path, and the powder channel opening is driven to synchronously move with the lasers, wherein the original position and the final position are located at two opposite sides of the processing plate, respectively, and the scanning path is a zig-zag route.
